(19) United States
(12) Patent Application Publication
(10) Pub. No.: US 2023/0019275 A1
(43) Pub. Date: Jan. 19, 2023

(54) INFORMATION PROCESSING APPARATUS, INFORMATION PROCESSING METHOD, NON-TRANSITORY COMPUTER READABLE MEDIUM

(71) Applicant: NEC Corporation, Minato-ku, Tokyo (JP)

(72) Inventor: Salita SOMBATSIRI, Tokyo (JP)

(73) Assignee: NEC Corporation, Minato-ku, Tokyo (JP)

(21) Appl. No.: 17/777,332

(22) PCT Filed: Nov. 19, 2019
(86) PCT No.: PCT/JP2019/045281

§ 371 Date: May 17, 2022

(51) Int. Cl. G06N 3/08; G06N 3/04

(52) U.S. Cl. CPC G06N 3/08; G06N 3/04

(57) ABSTRACT

A Model training system includes An ANN model trainer means for training an ANN model using training data, an Information matrix computation means for computing information matrix, which implies the importance of ANN parameters, from training information, and a Policy model trainer means for training traditional light-weight machine learning (non-DL) policy model using the training data and the information from the information matrix. Accordingly, the policy model can generate policy that indicates the important ANN parameters for omitting some inference computation of the ANN model.

### TECHNICAL FIELD

The present disclosure relates to an information processing apparatus, information processing method, program, and in particular, to a information processing apparatus, information processing method and program for accelerating artificial neural network (NN) inference, and, in particular, is capable of building a policy model and an ANN model.

### BACKGROUND ART

<Part1 DL and NN Cause Large Computation>

In recent years, deep learning (DL) has been studied and applied for the tasks in various fields of applications, such as computer vision, natural language processing, signal processing and etc. The tasks may include, for example, classification (image classification, normal/abnormal classification, etc.), recognition (speech recognition, etc.), detection (object detection, anomaly detection, etc.), regression (price forecasting, etc.), and generations (voice/text/image generation, etc.). The problem of a task is formulated as follows:

Input X is a set of N instances
an instance xₜ ∈X is a Dₓ-dimensional input (xₜ ∈R^{Dx})) of instance t,
   where t={1,2,3, . . . , N}

Output Y is a set of output vectors of N instances
an output yₜ ∈Y is a D_{y}-dimensional output of instance t.

Objective Find f:X→Y means Function f that maps X to Y

Here, yₜ can be of any form depending on the task. For example, yₜ can be a class of object within an image for image classification, a sentence for speech recognition, or a class and a bounding box of object within an image for image-based object detection. In the deep learning, the function f is represented using artificial neural networks (ANN), including multilayer perceptron (MLP), convolutional neural networks (CNN), recurrent neural networks (RNN), and etc. These models are composed of several kinds of layers, for example, fully connected layer, convolutional layer, recurrent layer, subsampling layer (pooling layer), normalization layer, and non-linear function layer. Generally, the layers may include, especially the fully connected layer, the convolutional layer and the recurrent layer, trainable ANN parameters, aka weights or kernels, for performing multiply-accumulate (MAC) operations.

The processing of ANN is divided into two phases: training phase and inference phase. In the training phase, the training data, which is defined with a set {(xₜ, yₜ)|xₜ∈X,yₜ ∈Y}, is used to adjust (train) the ANN parameters. The training data is the input data and its label, such as image and the label of the image. In the inference phase, given a set of new data {x′ₜ|x′ₜ ∈X′}, the ANN inference processing is performed to predict the output {y′ₜ} as ANN inference result. The set of new data may include a single new data or a plurality of new data.

FIG. 9 and FIG. 10 illustrate two examples of ANN and their trainable parameters, θ. FIG. 9 illustrates an example of a MLP. The element 201 shows the architecture of the MLP. The symbols are defined as follows:

xₜ denotes the input;

Lᵢ denotes the layers of this MLP, where N is the number of layers and

0<i≤N

;

θ denotes the trainable parameters and is defined as in element 202;

θ_{Li} denotes the trainable parameters of Lᵢ and is defined as in element 203;

θ_{WLi} de notes the trainable weight parameter matrix of Lᵢ and is defined as in element 204;

θ_{bLi} denotes the trainable bias parameter vector of Lᵢ and is defined as in element 205;

θ_{wLi(j,k)} denotes the weight value of Lᵢ in the position (j,k) of θ_{WLi}, where

0≤j<h_{Li-1}

and

0≤k<h_{Li}

;

h_{Li} is the number of neurons in Lᵢ and h_{L0} is the number of elements in the input vector xₜ; and

θ_{bLi(k)} denotes the bias value of Lᵢ in the kth position of θ_{bLi}, (omitted for simplicity in FIG. 9).

FIG. 10 illustrates an example of a CNN. The element 301 shows the architecture of the CNN. The symbols are defined as follows:

xₜ denotes the input;

Lᵢ denotes the layers of this MLP, where N is the number of layers and

0<i≤N

;

θ denotes the trainable parameters and is defined in the same manner as in element 202;

θ_{Li}, denotes the trainable parameters of Lᵢ and is defined in the same manner as in element 203;

θ_{WLi} denotes the multi-dimensional trainable weight parameter tensor of Lᵢ and is defined as in element 302;

θ_{bLi} denotes the trainable bias parameter vector of Lᵢ and is defined as in element 303;

θ_{WLi(j,k,l,m)} denotes the weight value of Lᵢ in the position (j,k,l,m) of θ_{WLi}, where

0≤j<cᵢ,0≤k<cᵢ₋₁,0≤1<kᵥᵢ,0≤m<kₕᵢ;

cᵢ is the number of channels of Lᵢ, and kₕᵢ, kᵥᵢ are the size of kernels of Lᵢ.

θ_{bLi(j)} denotes the bias value of Lᵢ in the j^{th} position of θ_{bLi} (omitted for simplicity in FIG. 10).

<Part 2 Computation Reduction According to Input>

Recent state-of-the-art deep learning models achieve remarkable classification or detection accuracy with large ANN models that involves a large amount of parameters and computations in order to extract good features for prediction of the complicated input. However, not all inputs are complex, and hence such large amount of parameters and computations are not required. Some computations can be omitted. This possibility is shown in the following Non-Patent Literatures.

Non-Patent Literature 1 and Non-Patent Literature 2 disclose adaptive computation time method for accelerating the NN. The method described in Non-Patent Literature 1 stops the inference processing of RNN by computing halting score for each layer. The method described in Non-Patent Literature 2 stops the inference processing of CNN by computing halting score for each layer and each layer's input pixel. The halting score of both literatures are computed within the NN itself with a separate matrix multiplication or convolutional layers. Even though training the NN and halting score function simultaneously is straight-forward, there are two problem. First, the halting score function itself is also computation-intensive computations like the matrix multiplication or convolution. Second, the halting score function is accumulated from the first layer to later layers, so the deep features may not be computed in the case that the halting score reaches the stopping threshold in the earlier layers, and hence, the accuracy may decreases.

Non-Patent Literature 3 and Non-Patent Literature 4 disclose a network, aka policy model, to determine which residual block of the ResNet can be omitted during the inference phase of each input data.

The Non-Patent Literature 3 introduces a gating network to determine a policy to compute or omit each ResNet's residual block layer by layer. In the training phase, the gating network is trained with a hybrid method between supervised learning (back propagation against the true label of a classification/detection task) and a reinforcement learning (randomly drop the computation of some residual blocks) in order to minimize the computation of the inference phase. In the inference phase, the gating network of each layer computes a policy for each layer, and according to that policy, the computation of each residual block takes place or is omitted.

Non-Patent Literature 4 introduces a policy network to determine a policy of computing or omitting all ResNet's residual block. In the training phase, the policy network is trained with a reinforcement learning. In the inference phase, the policy network determines the policy of the residual blocks, and then, the inference (prediction using ResNet) is computed according to the policy.

The problems of Non-Patent Literature 3 and Non-Patent Literature 4 are (1) the gating network and policy network are computation-intensive because it includes the convolutional layers, recurrent layers and fully-connected layers; (2) the reinforcement learning may not result in a good policy that minimize the computation while preserving the accuracy because the search space of the gating network and policy network are large.

<Part 3 FIM>

Fisher information matrix (FIM) represents the amount of information that an observable random variable X carries about an unknown parameter θ of a distribution within a model. It is the variance of the score, or the expected value of the observed information. Non-Patent Literature 5 uses FIM in specifying which layer of the ANN is important to each task in order to solve catastrophic forgetting of the incremental learning. FIM can be obtained from the gradient during the training phase. However, the use of FIM has not been applied to inference acceleration because the gradient cannot be extracted during the inference phase.

### CITATION LIST

### Non Patent Literature

[Non-Patent Literature 1] “Adaptive Computation Time for Recurrent Neural Networks” written by Alex Graves, published in 2016 by arXiv preprint arXiv: 1603.08983
[Non-Patent Literature 2] “Spatially Adaptive Computation Time for Residual Networks” written by Figurnov et al., published in 2017 at CVPR2017
[Non-Patent Literature 3] “SkipNet: Learning Dynamic Routing in Convolutional Networks” written by Wang et al., published in 2018 at ECCV2018
[Non-Patent Literature 4] “BlockDrop: Dynamic Inference Paths in Residual

Networks” written by Wu et al., published in 2018 at CVPR2018
[Non-Patent Literature 5] “Overcoming catastrophic forgetting in neural networks” written by Kirkpatrick et al., published in 2016 by arXiv preprint arXiv: 1612.00796

### SUMMARY OF INVENTION

### Technical Problem

A first problem is that it is difficult to find a policy model that generates a good policy for omitting some computation of the ANN model on a per-input basis while preserving the prediction accuracy as much as possible. The good policy means a policy that can omit as large amount of computation as possible while the prediction is still correct.

The first problem may occur because the method of training the policy model randomly omits the computation of the ANN model for each input data. Omitting some computation of the ANN model causes an inference time-accuracy trade-off; the shorter inference time is, the less accuracy is. There is no specific policy for omitting the computation for each input instance. The search space of the policy model is so enormous that randomly omitting the computation of the ANN model like the existing Non-Patent Literature 3 and Non-Patent Literature 4 is time-consuming and may not yield a good policy model.

A second problem is that the computation for generating a policy for each input instance of the existing literatures is computation-intensive.

The second problem may occur because the policy model of the existing literatures (Non-Patent Literature 1, Non-Patent Literature 2, Non-Patent Literature 3, Non-Patent Literature 4) is also an ANN model. As a consequence, the computation and inference time of the policy model are still considerably large.

The present disclosure has been made in view of at least one of the above-mentioned problems, and an objective of the present disclosure is to provide an effective way to train the policy network.

Another objective of the present disclosure is to provide a light-weight policy model by using the traditional machine learning model to generate the policy.

### Solution to Problem

An aspect of the present disclosure is an information processing apparatus including:

an ANN (artificial neural networks) model trainer means for training an ANN model using training data;

an Information matrix computation means for computing information matrix of each sample in the training data using training information extracted by the ANN model trainer means; and

a Policy model trainer means for training a Policy model using the Training data and the Information matrix.

An aspect of the present disclosure is an information processing method including:

training an ANN model using training data;

computing an information matrix of each sample in the training data using training information extracted during the ANN model training; and

training a Policy model using the Training data and the Information matrix.

An aspect of the present disclosure is a non-transitory computer readable medium storing a program for causing a computer to execute:

a process of training an ANN model using training data;

a process of computing the information matrix of each sample in the training data using training information extracted during the ANN model training; and

a process of training a Policy model using the Training data and the Information matrix.

### Advantageous Effects of Invention

A first effect is to ensure that the policy model generates a good policy for omitting some computation of the ANN model while preserving the prediction accuracy as much as possible.

The reason for the effect is that the policy model is built by considering important ANN parameters based on the ANN training information, which implies the ANN parameters that is important for inference processing of each training data.

A second effect is to ensure that the policy model generates a good policy for each new data with a small amount of computation.

The reason for the effect is that the policy model is built by using traditional light-weight machine learning (non-DL) model, which are properly trained based on the ANN training information.

### BRIEF DESCRIPTION OF DRAWINGS

FIG. 1 is a block diagram illustrating the structure according to a first exemplary embodiment of the present disclosure;

FIG. 2 is a flow diagram illustrating the operation of a first exemplary embodiment of the present disclosure;

FIG. 3 is a figure illustrating the Fisher information matrix;

FIG. 4 is a block diagram illustrating the structure of a second exemplary embodiment of the present disclosure;

FIG. 5 is a flow diagram illustrating the operation of a second exemplary embodiment of the present disclosure;

FIG. 6 is a block diagram illustrating the structure of a third exemplary embodiment of the present disclosure; and

FIG. 7 is a flow diagram illustrating the operation of a third exemplary embodiment of the present disclosure;

FIG. 8 is a block diagram showing the configuration example of the information processing apparatus 100, 200, 300;

FIG. 9 is a figure illustrating the structure and parameters of a MLP; and

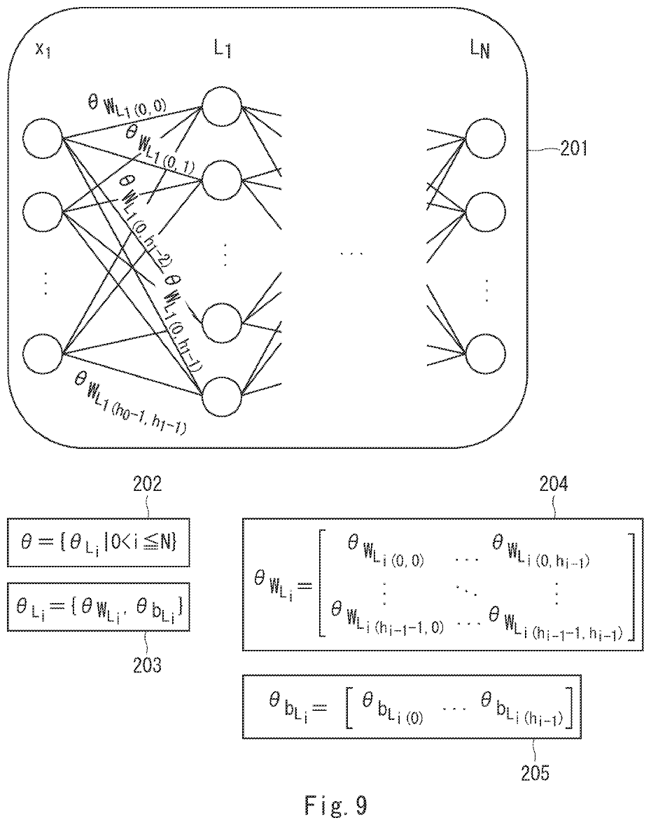

FIG. 10 is a figure illustrating the structure and parameters of a CNN.

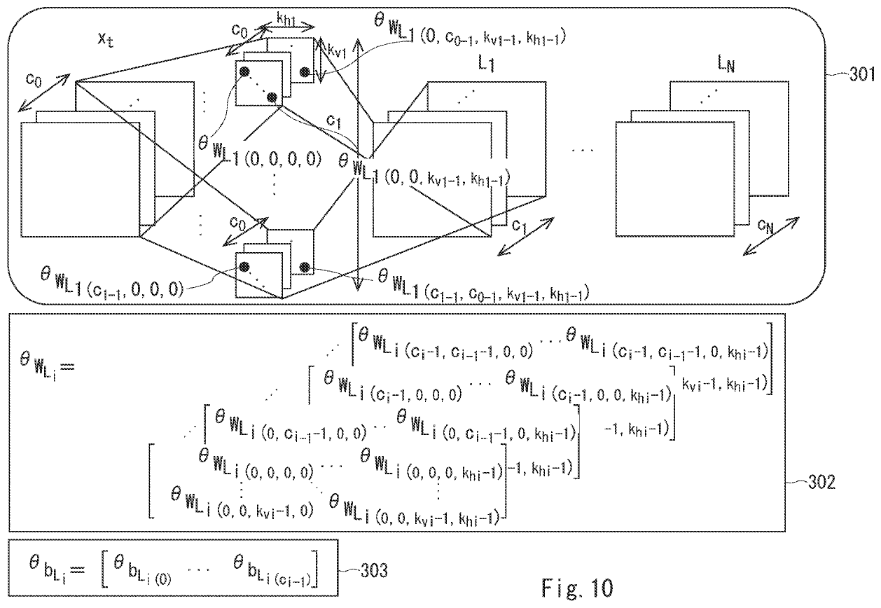

### DESCRIPTION OF EMBODIMENTS

Exemplary embodiments of the present disclosure are described in detail below referring to the accompanying drawings.

### First Exemplary Embodiment

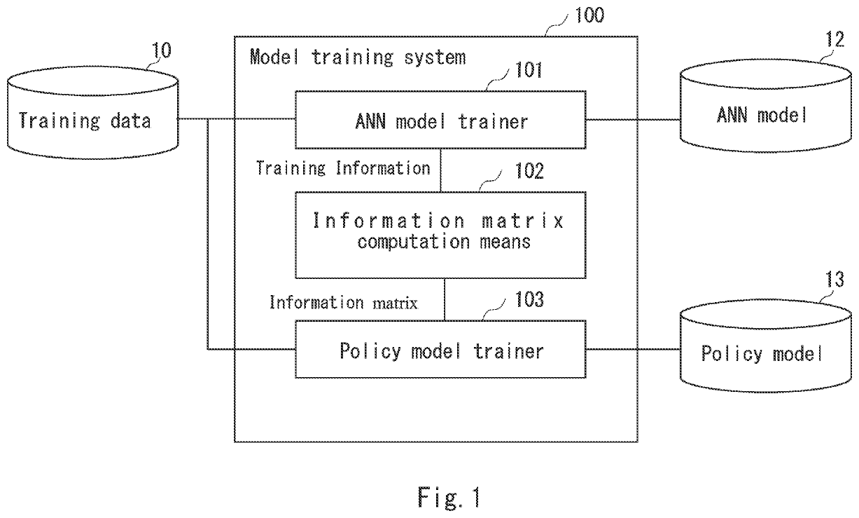

Referring to FIG. 1, a model training system 100 according to the first exemplary embodiment of the present disclosure will be described. The model training system 100 includes ANN model trainer means 101, Information matrix computation from training information means 102 and Policy model trainer means 103. The model trainer system 100 can be implemented using, but not limited to, a general-purpose processor system or a specific circuit, such as Graphic Processing Unit (GPU), Application-Specific Integrated Circuit (ASIC) and Application-Specific Instruction set Processor (ASIP), and a reconfigurable devices, such as Field Programmable Gate Array (FPGA). The model trainer system may be implemented by one or more functional modules in information processing apparatus such as general purpose processors or application specific chips.

The model training system 100 receives Training data 10. The training data 10 is defined with a set of pairs of input and expected output, aka label, of a task ({(xₜ, yₜ)|xₜ ∈X, yₜ ∈Y}) for training and validation in the training phase. The set may contain one or a plurality of pairs of input and output of a task. The model training system 100 outputs an ANN model 12 and a Policy model 13. The policy model generates a per-input policy. The ANN model 12 predicts an output of a task (yₜ) in the inference phase by computing or omitting the operations according to the policy. The policy model is to be used for determining the ANN parameters, aka weights or kernels, which are to be engaged in or omitted during ANN inference. The ANN model is to be used for generating/predicting the output of tasks like, but not limited to, labelling, classification, regression, detection, and etc. The computation of the ANN inference is according to the policy generated from the policy model. The policy is used to compute or omit each ResNet's residual block layer by layer. The present invention leverages the information from the ANN training to train the policy network and thereby trains a policy network to generate a good per-input policy for omitting some inference computation according to each input data within a short time. Accordingly, the policy model according to the present embodiment can generate a good policy for omitting some computation of the ANN model on a per-input basis while preserving the prediction accuracy as much as possible.

The Model training system 100 is capable of training an ANN model 12 and a policy model 13 for a given task. The Model training system 100 collects the information from the ANN training phase (hereinafter referred to as Training information), extracts the importance of each ANN parameter from the Training information (as described later with math 2), and uses the importance of ANN parameters (may be referred to as Information matrix) to train the Policy model. The “Training information” is any values or information generated during the ANN training such as parameters, gradient, moving average, etc. Consequently, the Policy model training requires shorter time and becomes easy because the light-weighted traditional machine learning Policy model can be trained to effectively generate a good per-input policy. Hence, the ANN inference using that policy can skip some computation in the ANN model, then, the ANN inference system can reduce computation time, while maintaining the prediction accuracy and suppressing the small overhead for computing the policy.

The above mentioned means generally operate as follows.

The ANN model trainer means 101 trains the ANN model 12 with the gradient-based learning algorithm using the Training data 10. After the ANN training, the training information is derived from the ANN model trainer means 101. The Training information, which indicates the importance of each ANN parameter, is different from the training data, as defined above. The Information matrix computation means 102 computes an information matrix using the Training information. The information matrix implies the importance of ANN parameters in inference processing each xₜ in the Training data. The Policy model trainer means 103 trains the policy model 13. The policy model 13 is the model selected from one of the traditional machine learning methods, such as Support Vector Machine (SVM), nearest neighbors, random forest, and etc. The Policy model trainer means 103 generates a vector or matrix indicating important ANN parameters, which may be called an ANN-inference policy, for inference processing of each input. The ANN-inference policy indicates the parameters to compute or omit computing in the ANN inference phase. The policy model training uses xₜ of the Training data as input and information matrix as a label which indicates an expected output of the policy model.

<Description of Operation>

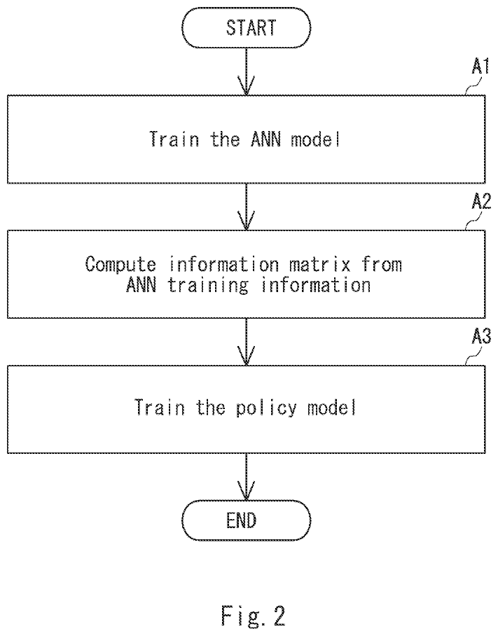

Next, referring to flowcharts in FIG. 2, the general operation of the present example embodiment is elaborated.

First, the model training means 101 trains the ANN model using the Training data with the gradient-based ANN training algorithm (step A1 in FIG. 2), specifically, gradient descent (e.g. stochastic gradient descent (SGD), SGD with momentum, Nesterov gradient descent, AdaGrad, RMSProp and Adam gradient descent, etc.). After the ANN training has finished, the Training information, specifically, the gradient of each sample is obtained. Let zₜ be each sample in the Training data, where zₜ=(xₜ, yₜ), and 1(zₜ, θ) be the loss of ANN model on sample zₜ when the parameter of the ANN model takes value θ. The loss of ANN model can be defined as, but not limited to, a log likelihood function, a mean square error, or etc. The gradient of sample zₜ, which is represented by g(zₜ, θ), can be collected from the gradient of each zₜ that is computed during the ANN training or the gradient of each zₜ that is computed by the forward and backward propagation without weight update using the trained ANN model. The gradient is the first derivative of the loss and is computed with the following equation:

$${ℊ}_{{z}_{t} , θ} = \frac{\partial l ( {z}_{t} , θ )}{\partial θ} \qquad ( math 1 )$$

The Training information is sent to the Information matrix computation means 102. The ANN model trainer means 101 gives the trained ANN model as the output of the Model training system 100.

Then, the Information matrix computation means 102 computes the Information matrix from the training information received from the ANN model trainer means 101 (step A2 in FIG. 2). The Information matrix, specifically, Fisher information matrix (FIM), represents the amount of information about each ANN parameter in each sample zₜ. The Information matrix implies the importance of each parameter. The Fisher information matrix of sample zₜ when the parameter of the ANN model takes value θ, I(zₜ,θ), is computed by the following equation:

[symbol]

(zₜ,θ)=gzₜ,θ² (math 2)

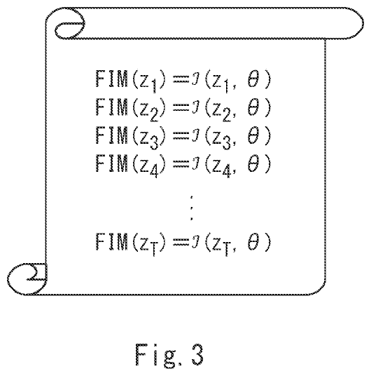

The I(zₜ,θ) is used to determine the important ANN parameters. An ANN parameter is more important for inference processing of xₜ when its corresponding value in I(zₜ,θ) is larger, but is less important when its value is smaller. FIG. 3 shows an example of the Information matrix sent to the Policy model trainer means 103. The Information matrix includes the FIM values for every zₜ in the Training data.

Next, the Policy model trainer means 103 trains a Policy model which is based on a traditional light-weight machine learning (non-DL) (step A3 in FIG. 2), so that the policy model can generate a policy that indicates the important ANN parameters for omitting some inference computation of the ANN model. The light-weight machine learning includes, but not limited to, SVM model, nearest neighbor model, random forest model, and etc. The Policy model trainer means 103 trains the policy model with a supervised learning method using the xₜ of the Training data or the features of xₜ as input of the policy model and the policy vector Mₜ as the expected output of the policy model, aka label. Here, the features of xₜ, represented by sₜ, means the output of feature extraction function of xₜ, which can be written as

sₜ=f(xₜ)

,
where

f(·)

is the feature extraction function. The feature extraction function can be, but not limited to, the principal component analysis (PCA), histogram of oriented gradients (HOG), or Scale-invariant feature transform (SIFT). Each element in Mₜ is a binary value {0,1} indicating whether or not each ANN parameter is important and should be engaged in inference processing (e.g. 0 is not important, 1 is important, or vice versa) of zₜ. The policy vector Mₜ is decided from the Information matrix with, but not limited to, a threshold value. If the element in the FIM is more than the threshold, the element in Mₜ corresponding to the same ANN parameter is 1, otherwise, the element in Mₜ is 0. The Policy model trainer means 103 gives the trained Policy model 13 as an output of the model training system 100.

Note that the ANN training algorithm in step A1 may be another gradient-based training algorithm, such as the conjugate gradient training algorithm, or other the non-gradient training algorithm, such as Newton's method or Quasi-Newton method. In the case of the non-gradient training algorithm, the gradient can be extracted by forward and backward propagation.

Note that the training information obtained from step A1 may also be or includes other information during ANN training phase, such as loss, intermediate value, etc.

Note that the Information matrix obtained from step A2 may also be other matrix, such as Hessian matrix, Jacobian matrix, or etc. Note that the policy model in step A3 can also be a kind of ANN. The binary value of Mₜ in step A3 may be other values such as {−1,1}. The decision of binary value in step A3 may also be other than the threshold. For example, the elements in Mₜ corresponding to the top-k FIM values are decided as 1, other elements are 0. Note that, in training the policy model in step A3, Mₜ may also be the Information matrix itself or in the form after some transformation, such as value scaling, normalization. The value k can be varied for each sample xₜ, so that the number of remaining computation is the smallest, while the prediction is still correct. The policy vector Mₜ is also be decided from the combination of more than one of these information matrices. For example, the combination of FIM and Jacobian matrix is used to decide the policy vector Mₜ.

In step A3, the elements in Mₜ can represent the policy of groups ANN parameters, for instance, the groups of ANN parameters in the same channel, layer, or multiple layers (ex. ResNet's block). In this case, the Fisher information value may be, but not limited to, an average, max or sum value of each Fisher information value of the parameters in the same group. For example, assuming that an ANN contains four layers ([L₁, L₂, L₃, L₄]), the policy Mₜ=[0,1,1,1] and each element of Mₜ is for all parameters of a layer.

The inference phase includes two steps: policy extraction and ANN inference processing. Given an Inference data xₜ′. In the policy extraction step, the policy model takes xₜ′ as input and generates a policy vector Mₜ′, in which each element is the policy for each ANN parameter in a layer. For example, assuming that an ANN contains four layers ([L₁, L₂, L₃, L₄]), the policy model generates a policy M′ₜ=[0,1,1,1] for inference data xₜ′. In the ANN inference processing, the computation of the layers whose policy is 1 takes place, while the computation of the layers whose policy is 0 is skipped. In this example, the inference processing of the ANN model computes only layer L₂, L₃, L₄ and skips the computation of L₁.

### <Description of Effect>

Next, the effect of the present exemplary embodiment is described.

The present exemplary embodiment is configured in such a manner that the model training system 100 trains the policy model with the information from the training phase, which can imply the important ANN parameters. Accordingly, it is capable of generating a good policy for omitting some computation of the ANN model while preserving the prediction accuracy as much as possible.

In addition, as the exemplary embodiment is configured in such a manner that the policy model is built from the light-weight traditional machine learning model, the overhead of computing the policy can be reduced.

### Second Exemplary Embodiment: Incremental Learning

### <Explanation of Structure>

Next, a second exemplary embodiment of the present disclosure is elaborated referring to the accompanying drawings.

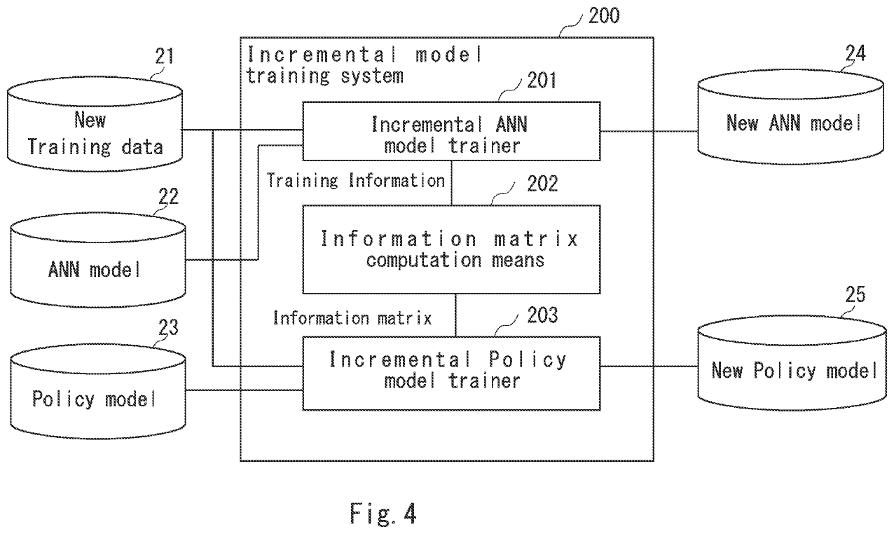

Referring to FIG. 4, an Incremental model training system 200 according to the second exemplary embodiment of the present disclosure includes Incremental ANN model trainer means 201, Information matrix computation means 202 and Incremental policy model trainer means 203.

The incremental model training system 200 receives New training data 21, ANN model 12 and Policy model 13. The New training data is a set of pairs of input and expected output, aka label, of a task for training and validation in the incremental training phase that is additional to the Training data in the First Embodiment. The set may contain one or a plurality of pairs of input and output of a task. The ANN model 22 and the Policy model 23 are the trained ANN model and Policy model, respectively, from the First Embodiment.

The incremental model training system 200 outputs New ANN model 24 and New policy model 25. The New ANN model 24 and New policy model 25 are the models that are incrementally trained from the ANN model 22 and Policy model 23 with the New training data 21.

The Incremental model training system 200 is capable of incrementally finetuning the ANN model and/or the policy model with the New training data, so the models can adjust to other new data, and if the New training data contains new categories (such as data of a new class in classification problem), the models can also learn the new categories.

The above mentioned means generally operate as follows.

The Incremental ANN model trainer means 201 trains the ANN model incrementally from the input ANN model with the New training data 21.

The Information matrix computation means 202 operates in the same manner as the Information matrix computation means 102 in FIG. 1.

The Incremental policy model trainer means 203 trains the Policy model incrementally from the input Policy model with the New training data 21.

### <Description of Operation>

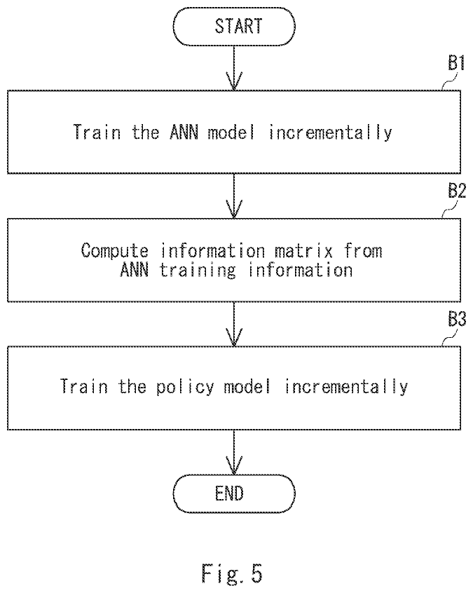

Next, referring to flowcharts in FIG. 5, the general operation of the present example embodiment is elaborated.

First, the Incremental ANN model trainer means 201 trains the ANN model incrementally from the input ANN model with the New training data (step B1). The Incremental ANN model trainer means 201 trains the ANN model with the incremental learning method or in the same manner as the Information matrix computation means 101 in FIG. 1. The Incremental ANN model trainer means 201 gives the New ANN model 24 as output of the Incremental model training system 200.

Then, in step B2, the Information matrix computation means 202 operates in the same manner as the Information matrix computation means 102 in FIG. 1 for the New training data 21.

Finally, in step B3, the Incremental policy model trainer means 203 trains the Policy model incrementally from the input Policy model with the New training data 21. The Incremental policy model trainer means 203 trains the Policy model with the incremental learning method or in the same manner as the policy model trainer means 103 in FIG. 1. The Incremental policy model trainer means 203 gives the New policy model 25 as output of the Incremental model training system 200.

Note that the Training data of the First Embodiment can also be used for incremental learning in this second embodiment. Note that, if there are no new categories in the New training data, the step B1 can be skipped.

### <Description of Effect>

Next, the effect of the present exemplary embodiment is described.

As the present exemplary embodiment is configured in such a manner that the system 200 can incrementally finetune the ANN model and policy model, it is capable of handling new data and new label.

### Third Exemplary Embodiment: Finetuning

### <Explanation of Structure>

Next, a third exemplary embodiment of the invention is elaborated below referring to the accompanying drawings.

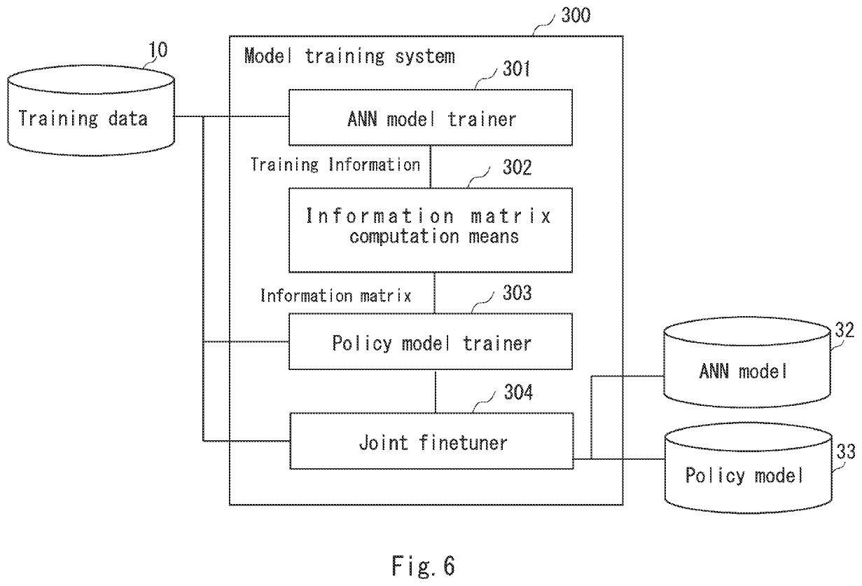

Referring to FIG. 6, the Model training system 300 includes an ANN model trainer means 301, an Information matrix computation means 302, and a Policy model trainer 303. Also the Model training system 300 further includes the Joint finetuner means 304. The Joint finetuner means 304 jointly finetunes the ANN model and the Policy model. The Joint finetuner means 304 outputs the finetuned ANN model 32 and finetuned Policy model 33. According to this embodiment, a more aggressive policy can be achieved, and thus more computation can be omitted.

### <Explanation of Operation>

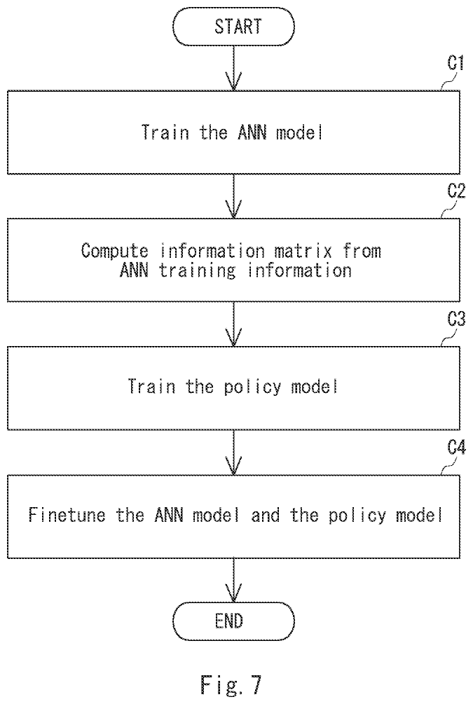

Next, referring to flowcharts in FIG. 7, the general operation of the present exemplary embodiment is elaborated. In step C4, the Joint finetuner means 304 finetunes the ANN model and Policy model (optional) in accordance to the policy generated from the Policy model.

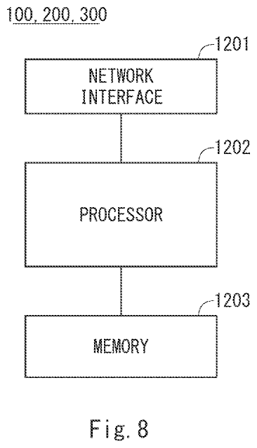

FIG. 8 is a block diagram showing the configuration example of the information processing apparatus 100, 200, 300. Referring to FIG. 8, the information processing apparatus 100, 200, 300 includes a network interface 1201, a processor 1202, and a memory 1203. The network interface 1201 is used to communicate with the network node (e.g., eNB, MME, SGW, P-GW). The network interface 1201 may include, for example, a network interface card (NIC) conforming to the IEEE 802.3 series.

The processor 1202 loads software (computer program) from the memory 1203 and executes the loaded software, thereby performing the processing of the information processing apparatus 100, 200, 300 described with reference to the sequence diagrams and flowcharts in the aforementioned embodiments. The processor 1202 may be, for example, a microprocessor, an MPU, or a CPU. The processor 1202 may include a plurality of processors. The information processing apparatus 100, 200, 300 may also include GPU, FPGA or other ASIC accelerator.

The memory 1203 is composed of a combination of a volatile memory and a non-volatile memory. The memory 1203 may include a storage that is located apart from the processor 1202. In this case, the processor 1202 may access the memory 1203 via an I/O interface (not shown).

In the example shown in FIG. 8, the memory 1203 is used to store software modules. The processor 1202 loads these software modules from the memory 1203 and executes these loaded software modules, thereby performing the processing of the information processing apparatus 100, 200, 300 described in the aforementioned embodiments.

In the aforementioned embodiments, the program(s) can be stored and provided to a computer using any type of non-transitory computer readable media. Non-transitory computer readable media include any type of tangible storage media. Examples of non-transitory computer readable media include magnetic storage media (such as flexible disks, magnetic tapes, hard disk drives, etc.), optical magnetic storage media (e.g., magnetooptical disks), Compact Disc Read Only Memory (CD-ROM), CD-R, CD-R/W, and semiconductor memories (such as mask ROM, Programmable ROM (PROM), Erasable PROM (EPROM), flash ROM, Random Access Memory (RAM), etc.). The program(s) may be provided to a computer using any type of transitory computer readable media. Examples of transitory computer readable media include electric signals, optical signals, and electromagnetic waves. Transitory computer readable media can provide the program to a computer via a wired communication line (e.g., electric wires, and optical fibers) or a wireless communication line.

While the present invention has been described above with reference to exemplary embodiments, the present invention is not limited to the above exemplary embodiments. The configuration and details of the present invention can be modified in various ways which can be understood by those skilled in the art within the scope of the invention.

Part of or all the foregoing embodiments can be described as in the following appendixes, but the present disclosure is not limited thereto.

### (Supplementary Note 1)

An information processing apparatus comprising:

an ANN (artificial neural networks) model trainer means for training an ANN model using training data;

an Information matrix computation means for computing information matrix of each sample in the training data using the training information extracted by the ANN model trainer means; and

a Policy model trainer means for training a Policy model using the Training data and the Information matrix.

### (Supplementary Note 2)

The information processing apparatus according to note 1, further comprising:

an Incremental ANN model trainer means for training the ANN model incrementally from the input ANN model with the New training data;

the Information matrix computation means for computing the information matrix of each sample in a New training data using the training information; and

an Incremental policy model trainer means for training the Policy model incrementally from the input Policy model with the New training data.

### (Supplementary Note 3)

The information processing apparatus according to note 1 or note 2, further comprising:

a Joint finetuner means for jointly finetuning the ANN model and the Policy model.

### (Supplementary Note 4)

The information processing apparatus according to any one of notes 1 to 3, wherein the Policy model is a light-weight Policy model based on a traditional machine learning model with a supervised learning.

### (Supplementary Note 5)

An information processing method comprising:

training an ANN model using training data;

computing an information matrix of each sample in the training data using the training information extracted during the ANN model training; and

training a Policy model using the Training data and the Information matrix.

### (Supplementary Note 6)

The information processing method according to note 5, further comprising:

training an ANN model incrementally from the input ANN model with a New training data;

computing the Information matrix of the New training data and/or Training data; and

training a Policy model incrementally from the input Policy model with the New training data.

### (Supplementary Note 7)

The information processing method according to note 5 or note 6, further comprising:

jointly finetuning the ANN model and the Policy model.

### (Supplementary Note 8)

The information processing method according to any one of notes 5 to 7, wherein the Policy model is a light weight Policy model based on a traditional machine learning model with a supervised learning.

### (Supplementary Note 9)

A non-transitory computer readable medium storing a program for causing a computer to execute:

a process of training an ANN model using training data;

a process of computing the information matrix of each sample in the training data using the training information extracted during the ANN model training; and

a process of training a Policy model using the Training data and the Information matrix.

### (Supplementary Note 10)

The non-transitory computer readable medium according to note 9, wherein the program for causing a computer to execute:

a process of training the ANN model incrementally from the input ANN model with a New training data;

a process of computing the Information matrix of the New training data and/or Training data; and

a process of training a Policy model incrementally from the input Policy model with the New training data.

### (Supplementary Note 11)

The non-transitory computer readable medium according to note 9 or note 10, further causing a computer to execute:

a process of jointly finetuning the ANN model and the Policy model.

### (Supplementary Note 12)

The non-transitory computer readable medium according to any one of notes 9 to 11, wherein the Policy model is a light-weight Policy model based on a traditional machine learning model with a supervised learning.

### INDUSTRIAL APPLICABILITY

The present invention is applicable to system and apparatus for an ANN-based classification/detection/recognition system. The present invention is also applicable to applications such as image classification, object detection, human tracking, scene labelling, and other applications for classification and artificial intelligence.

### REFERENCE SIGNS LIST

10 Training data
12, 22 ANN model
13, 23 Policy model
21 New Training data
24 New ANN model
25 New ANN model
100 Model training system
101 ANN model trainer means
102 Information matrix computation means
103 Policy model trainer means
200 Incremental model training system
201 Incremental ANN model trainer means
202 Information matrix computation means
203 Incremental policy model trainer means
300 Model training system
301 ANN model trainer means
302 Information matrix computation means
303 Policy model trainer means
304 Joint finetuner means

What is claimed is:

1. An information processing apparatus comprising:
an ANN (artificial neural networks) model trainer configured to train an ANN model using training data;
an Information matrix computation unit configured to compute information matrix of each sample in the training data using training information extracted by the ANN model trainer; and
a Policy model trainer configured to train a Policy model using the Training data and the Information matrix.

2. The information processing apparatus according to claim 1, further comprising:
an Incremental ANN model trainer configured to train the ANN model incrementally from the input ANN model with the New training data;
the Information matrix computation unit configured to compute the information matrix of each sample in the New training data using the training information; and
an Incremental policy model trainer configured to train the Policy model incrementally from the input Policy model with the New training data.

3. The information processing apparatus according to claim 1, further comprising:
a Joint finetuner unit configured to jointly finetune the ANN model and the Policy model.

4. The information processing apparatus according to claim 1, wherein the Policy model is a light-weight Policy model based on a traditional machine learning model with a supervised learning.

5. An information processing method comprising:
training an ANN model using training data;
computing an information matrix of each sample in the training data using training information extracted during the ANN model training; and
training a Policy model using the Training data and the Information matrix.

6. The information processing method according to claim 5, further comprising:
training an ANN model incrementally from the input ANN model with a New training data;
computing the Information matrix of the New training data and/or Training data; and
training a Policy model incrementally from the input Policy model with the New training data.

7. The information processing method according to claim 5, further comprising:
jointly finetuning the ANN model and the Policy model.

8. The information processing method according to claim 5, wherein the Policy model is a light weight Policy model based on a traditional machine learning model with a supervised learning.

9. A non-transitory computer readable medium storing a program for causing a computer to execute:
a process of training an ANN model using training data;
a process of computing the information matrix of each sample in the training data using training information extracted during the ANN model training; and
a process of training a Policy model using the Training data and the Information matrix.

10. The non-transitory computer readable medium according to claim 9, wherein the program for causing a computer to execute:
a process of training the ANN model incrementally from the input ANN model with a New training data;
a process of computing the Information matrix of the New training data and/or Training data; and
a process of training a Policy model incrementally from the input Policy model with the New training data.

11. The non-transitory computer readable medium according to claim 9, further causing a computer to execute:
a process of jointly finetuning the ANN model and the Policy model.

12. The non-transitory computer readable medium according to claim 9, wherein the Policy model is a light-weight Policy model based on a traditional machine learning model with a supervised learning.
